(19) United States
(12) Patent Application Publication
(10) Pub. No.: US 2014/0126015 A1
(43) Pub. Date: May 8, 2014

(54) IMAGE FORMING APPARATUS AND METHOD OF CONTROLLING THE SAME, AND STORAGE MEDIUM

(71) Applicant: CANON KABUSHIKI KAISHA, Tokyo (JP)

(72) Inventor: Takayuki Kaneko, Machida-shi (JP)

(73) Assignee: CANON KABUSHIKI KAISHA, Tokyo (JP)

(21) Appl. No.: 14/050,982

(22) Filed: Oct. 10, 2013

(30) Foreign Application Priority Data
Nov. 7, 2012 (JP) 2012-245632

(51) Int. Cl. G06K 15/00

(52) U.S. Cl. CPC G06K 15/408
USPC 358/1.15

(57) ABSTRACT

When a print job containing a first job attribute is received, it is determined whether or not the print job is able to be executed in accordance with the first job attribute, based upon the information indicating a function or a status of the image forming apparatus. If it is determined that the print job is able to be executed in accordance with the first job attribute, the print job is executed in accordance with the first job attribute, and if it is determined that the print job is not able to be executed in accordance with the first job attribute, the print job is executed in accordance with a second job attribute and the print job is stored together with the second job attribute. When re-execution of the stored print job is designated, the stored print job is executed in accordance with the second job attribute.

### BACKGROUND OF THE INVENTION

1. Field of the Invention

The present invention relates to an image forming apparatus capable of holding and re-executing an executed print job, and relates also to method for controlling such image forming apparatus and storage media.

2. Description of the Related Art

Some recent image forming apparatuses such as copy machines, multi-function peripherals, and the like include storage devices such as high-capacity hard disks, and have reprint functions for saving image data, job attributes, and the like in the storage device and printing the corresponding job at a desired timing. If the result of printing a document using a copy function, a printer function of the image forming apparatus is unsatisfactory, the reprint function makes it possible to change some print settings and reprint the document without requiring the print data to be received again.

When reprinting a document stored in the image forming apparatus, a list of documents stored in the image forming apparatus is typically displayed and the desired document is selected from the list display and printed. However, there are cases where some stored documents cannot be printed using the specified print settings, and thus from the standpoint of convenience, it is undesirable to allow a document for reprinting to be selected and printed without displaying an indication that some of the documents that cannot be printed using the specified print settings in the document list. In response to this problem, Japanese Patent Laid-Open No. 2008-152726, for example, discloses a method in which information such as “printable with specified print settings”, “printable if attributes are changed”, or “not printable” is displayed along with a list of documents.

According to the method of Japanese Patent Laid-Open No. 2008-152726, whether or not image data stored in the storage device can be printed with the specified settings can be distinguished from the document list. However, this method does not make it possible to recognize situations where printing results will differ between initial prints using a copy function, or a printer function and reprints of documents stored in the storage device. Specifically, when, for example, color printing cannot be carried out in an initial print and thus the document is printed in black and white (reduced printing), it is not possible to recognize that color printing can be carried out when reprinting (reduction canceling). This recognition fails in the reverse case as well.

### SUMMARY OF THE INVENTION

An aspect of the present invention is to eliminate the above-mentioned problems with the conventional technology.

A feature of the present invention is to provide a technique for making it easy to understand whether or not the same execution result obtained in an initial print job that has been executed is able to be obtained when re-executing the print job.

According to an aspect of the present invention, there is provided an image forming apparatus comprising: a reception unit configured to receive a print job containing a first job attribute; an obtaining unit configured to obtain information indicating a function or a status of the image forming apparatus; a determination unit configured to determine whether or not to be able to execute the print job in accordance with the first job attribute, based upon the information obtained by the obtaining unit; an execution unit configured to execute the print job in accordance with the first job attribute in a case that it is determined by the determination unit that the print job is able to be executed in accordance with the first job attribute, or to execute the print job in accordance with a second job attribute, in a case that it is determined by the determination unit that the print job is not able to be executed in accordance with the first job attribute; a storage unit configured to store the print job that is determined not to be executed in accordance with the first job attribute and has been executed by the execution unit together with the second job attribute; and a control unit configured to, in a case that re-execution of a print job stored in the storage unit is designated, control the execution unit to re-execute the designated print job in accordance with the second job attribute.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating the configuration of an image forming apparatus according to a first embodiment.

FIG. 2 is a diagram illustrating control program modules of the image forming apparatus according to the first embodiment that are stored in an auxiliary storage device of the image forming apparatus.

FIG. 3 depicts a view illustrating an example of an operation mode setting screen for setting an operation mode of the image forming apparatus according to the first embodiment.

FIG. 4 depicts a view illustrating an example of a job history display screen displayed on a display unit by a job history display according to the first embodiment.

FIG. 5 depicts a view illustrating an example of a reprinting screen displayed by the image forming apparatus according to the first embodiment when a job is selected in the job history display screen shown in FIG. 4 and a reprint button is pressed.

FIG. 6 depicts a view illustrating an example of a reprinting screen displayed by the image forming apparatus according to the first embodiment when a job is selected in the job history display screen shown in FIG. 4 and a reprint button is pressed.

FIG. 7 depicts a view illustrating an example of a reprinting screen displayed by the image forming apparatus according to the first embodiment when a job is selected in the job history display screen shown in FIG. 4 and a reprint button is pressed.

FIG. 8 depicts a view illustrating an example of a preview screen displayed by an image forming apparatus according to a second embodiment when a job is selected in the screen shown in FIG. 4 and a preview button is pressed.

FIG. 9 depicts a view illustrating an example of a screen displayed by the image forming apparatus according to the second embodiment that arranges an initial print preview display and a reprint preview display so that the respective previews can be compared.

FIG. 10 is a diagram illustrating display elements that indicate stapling and punching attributes, displayed in a preview image according to the second embodiment.

FIG. 11 is a diagram illustrating operation modes managed by an operation mode manager using the auxiliary storage device or a RAM, according to the first embodiment.

FIG. 12 is a diagram illustrating a history data number indicating a number of pieces of history data held by a job history manager according to the first embodiment.

FIG. 13 is a diagram illustrating an example of history data held by the job history manager according to the first embodiment.

FIG. 14 is a diagram illustrating an example of job attribute data in the history data according to the first embodiment.

FIG. 15 is a diagram illustrating an example of initial print difference data according to the first embodiment.

FIG. 16 is a diagram illustrating an example of reprint difference data according to the first embodiment.

FIG. 17 is a flowchart for describing a printing process performed by the image forming apparatus according to the first embodiment during an initial print.

FIG. 18 is a flowchart for describing a process for displaying the job history display screen (FIG. 4) performed by the image forming apparatus according to the first embodiment.

FIG. 19 is a flowchart for describing a process performed by the image forming apparatus according to the first embodiment when a user selects a job in the job history display screen shown in FIG. 4 and presses the reprint button.

FIG. 20 is a flowchart for describing a process performed by the image forming apparatus according to the second embodiment when displaying a preview of a job.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

The embodiments will describe an example of an image forming apparatus capable of storing a print job that has already been printed and then reading out and reprinting the stored print job, where difference data of the already-printed job and difference data for the reprinting are displayed in a reprinting job list.

In the embodiments, “job” refers to an instance or unit of processing employed when printing a document using a copy function, a printer function, a reprint function, or the like. “Job attributes” indicate print format settings employed when executing a job, such as a number of copies, double-sided attributes, and the like. Printing a copy job, a printer job, or the like using the copy function, the printer function, or the like is defined as an “initial print”, whereas a process for storing image data used during the initial print and then reprinting that image data is defined as “reprinting”. “Difference data” refers to attribute information employed when executing a job whose attributes are different from the original attributes of the job. “Reduction” refers to processing a job with different attributes than the original attributes of the job due to, for example, problems with paper feed/discharge options, operation mode restrictions, and so on in the image forming apparatus. For example, a situation where the attributes of a print job specify double-sided printing but a double-sided printing unit is malfunctioning and the print job is thus printed on one side of paper is referred to as “reduced printing”. A situation where the attributes of a print job specify stapled printing but a finisher having a stapling function is not provided and the print job is thus executed without stapling is also referred to as “reduced printing”.

### First Embodiment

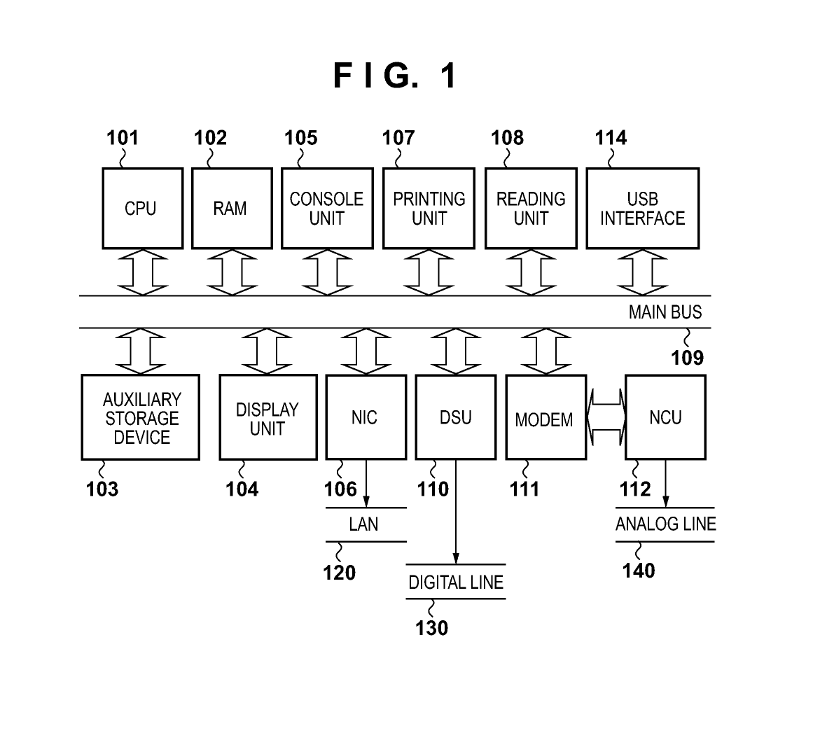

FIG. 1 is a block diagram illustrating the configuration of an image forming apparatus according to a first embodiment. Although a multifunction peripheral (MFP) having a copy function, a printer function, a box function, a facsimile function, a scanning function, and the like is given here as an example of the image forming apparatus, the present invention is not limited thereto.

A CPU 101 controls operations performed by the image forming apparatus in accordance with programs loaded from an auxiliary storage device 103 into a RAM 102. The RAM 102 provides a working area for the CPU 101, and temporarily holds programs, various types of data. The auxiliary storage device 103 is, for example, a hard disk, a CD-ROM, or the like that temporarily holds various types of programs, data, and so on. A display unit 104 includes a touch panel and displays statuses of the image forming apparatus, error messages, and the like. A console unit 105 is used in cases such as where a user manipulates a touch panel or the like to specify a desired print job. Note that the console unit 105 and the display unit 104 may be configured as an integral unit.

A network interface card (NIC) 106 exchanges data with other network devices via a LAN 120. A printing unit 107 is a printer engine for printing an image onto paper based on image data. The printing unit 107 is also capable of identifying states of paper feed options (e.g. different paper feed cassettes), discharge options (e.g. discharging to a finishing device) that relate to printing processes. A reading unit (scanner) 108 reads an original document placed on a document glass and generates monochrome binary or multivalued color image data. The image data obtained by the reading unit 108 reading the original document can be printed by the printing unit 107, and the image data can also be stored in the auxiliary storage device 103 and printed at a desired timing. A digital service unit (DSU) 110 is connected to a digital line 130 and is used to send and receive data. A network control unit (NCU) 112 is connected to an analog line 140 and is used to establish and terminate connections, control the sending and receiving of signals, send and receive image data (analog). A modem 111 modulates and demodulates sent and received data. A USB interface 114 sends and receives data to and from an external information terminal in accordance with the USB (universal serial bus) standard. The CPU 101 controls them via a main bus 109.

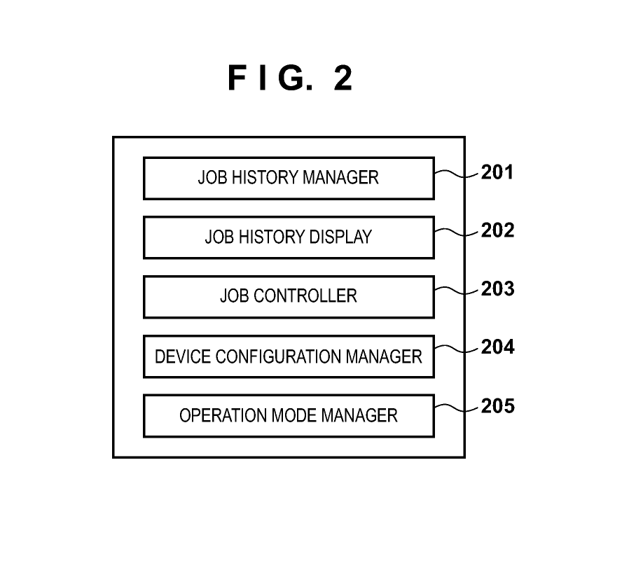

FIG. 2 is a diagram illustrating control program modules of the image forming apparatus according to the first embodiment that are stored in the auxiliary storage device 103 of the image forming apparatus. The programs that execute these control modules are read out from the auxiliary storage device 103 by the CPU 101 and loaded into the RAM 102 when the image forming apparatus is started up. The control program modules function by the CPU 101 executing those programs.

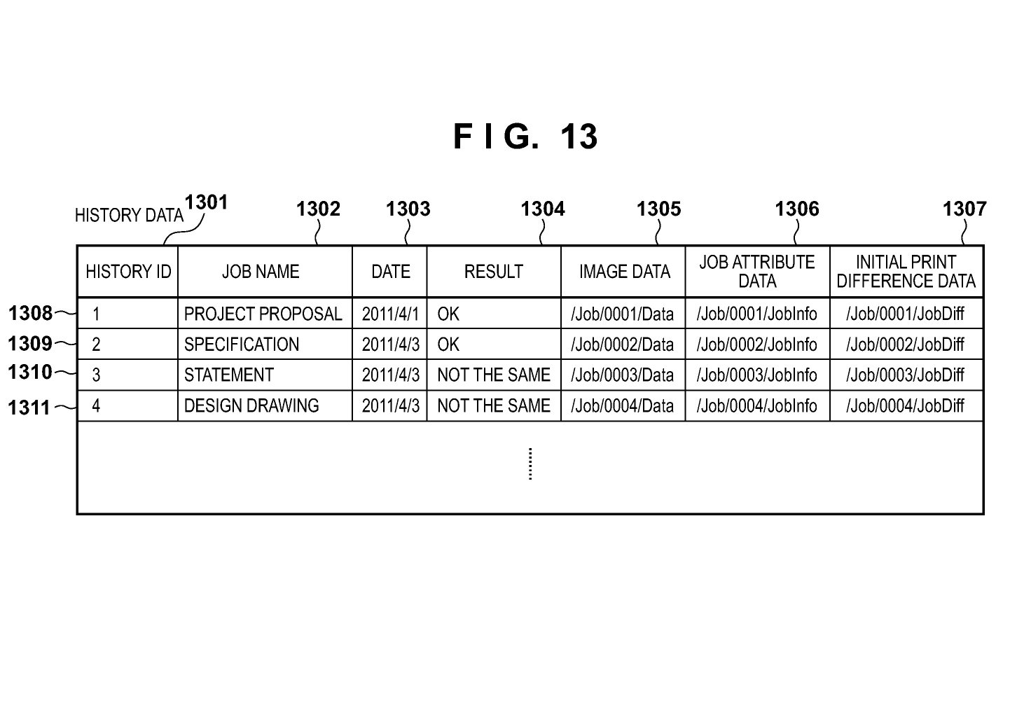

A job history manager 201 manages print job history data, and controls the updating, readout of the history data (see FIG. 13) stored in the auxiliary storage device 103. A job history display 202 displays the job history data, and displays the history data read out by the job history manager 201 on the display unit 104. A job controller 203 executes print jobs, scan jobs, and so on using the printing unit 107, the reading unit 108, and so on. The job controller 203 can update the job history data, such as whether or not a job was executed successfully, and can update a history data number (see FIG. 12), using the job history manager 201. The job controller 203 also stores image data and job attributes of an executed print job in the auxiliary storage device 103 via the job history manager 201. A device configuration manager 204 is a program module for identifying the device configuration of the printing unit 107, the reading unit 108 at a given timing. The “device configuration” of the printing unit 107 refers to types, statuses of paper feed tray information, discharge option information. “Discharge option information” refers to information indicating the presence/absence of a stapling function and the presence/absence of staples, for example. An operation mode manager 205 manages operation modes used when the job controller 203 controls jobs. “Operation modes” refers to modes for executing job operations that are independent from the job attributes, such as a forced monochrome print mode, a forced ID print mode, and the like.

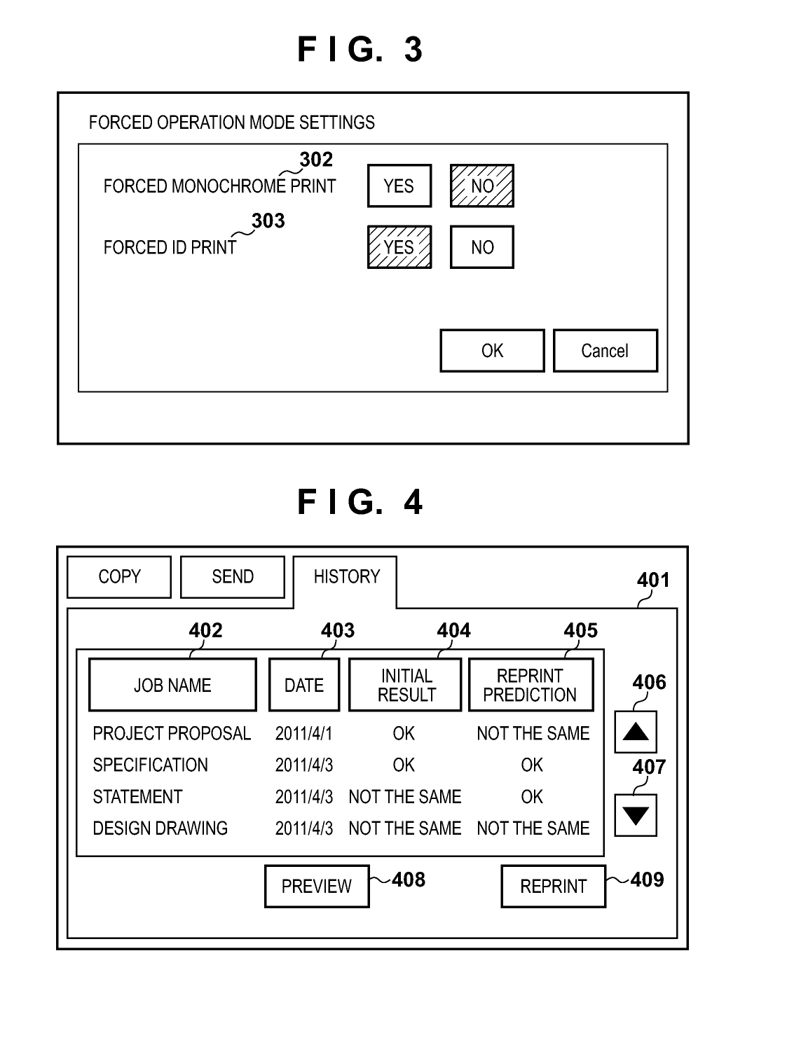

FIG. 3 depicts a view illustrating an example of an operation mode setting screen for setting the operation mode of the image forming apparatus according to the first embodiment. This screen is displayed on the display unit 104.

In the first embodiment, forced monochrome print 302 and forced ID print 303 can be set. Forced monochrome print 302 is a switch for forcing printing to be carried out in monochrome when the job controller 203 executes the print job. In the example shown in FIG. 3, “no” is indicated by hatching, thus indicating that the printing will not be forced to be carried out in monochrome. Forced ID print 303 is a switch for forcing an ID to be printed when the job controller 203 executes the print job. In the example shown in FIG. 3, “yes” is indicated by hatching, thus indicating that the ID will be forced to be printed.

Although the configuration may be such that the location, size, color, character string, and the like of the ID to be printed can be specified in the forced ID printing, the first embodiment assumes, for the sake of simplicity, a mode in which a user ID and a printing date are printed at the bottom of the paper in a character string having a fixed size and a fixed color. Furthermore, although a forced copy-forgery-inhibited pattern print function, a forced stamp function, a forced double-sided printing function, and the like may also be provided as other operation modes, descriptions thereof will be omitted from the first embodiment for the sake of simplicity.

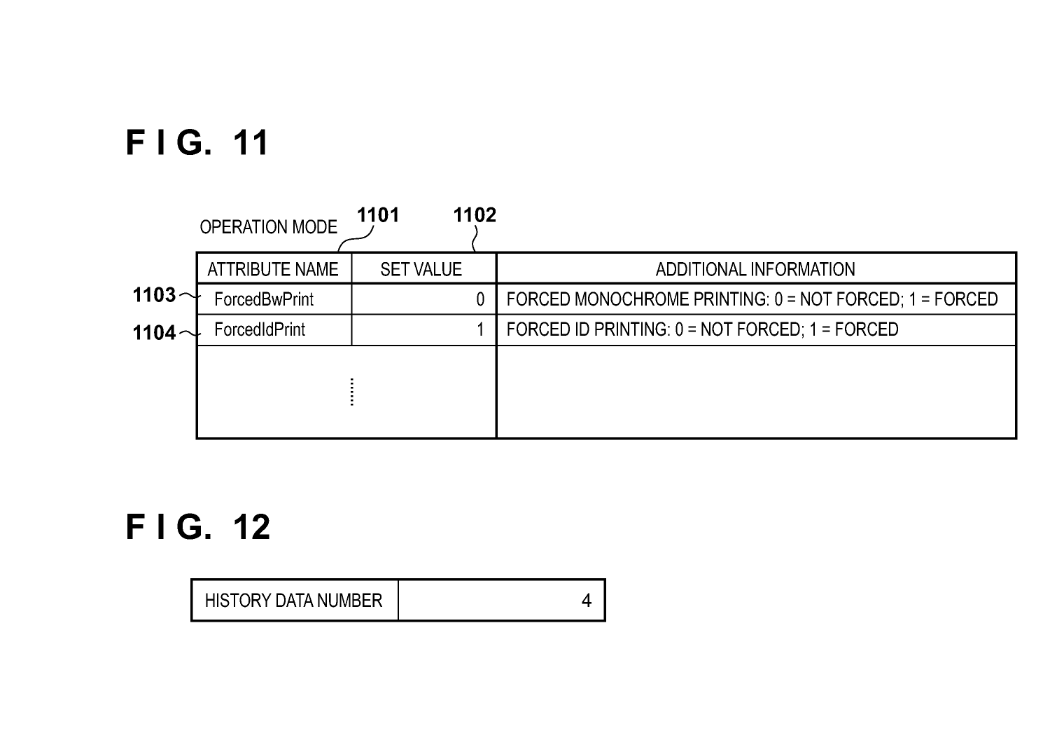

Next, information managed by the operation mode manager 205 and the job history manager 201 according to the first embodiment will be described with reference to FIGS. 11 to 14.

FIG. 11 is a diagram illustrating operation modes managed by the operation mode manager 205 using the auxiliary storage device 103 or the RAM 102, according to the first embodiment.

The operation modes shown in FIG. 11 indicate details that have been set by the user, using the settings screen shown in FIG. 3. It is assumed that these operation modes can be referred to by the job history display 202, the job controller 203, and so on at any given timing. Here, the forced monochrome print mode (ForcedBwPrint) and the forced ID print mode (ForcedIdPrint) are indicated as operation mode attribute names 1101. Set value 1102 indicates a value set for the corresponding operation mode. Here, “1” indicates “execute”, whereas “0” indicates “do not execute”. Reference numeral 1103 denotes the forced monochrome print mode, and the set value 1102 is set to “0” (indicating that the forced monochrome print mode will not be applied). Reference numeral 1104 denotes the forced ID print mode, and the set value 1102 is set to “1” (indicating that the forced ID print mode will be applied).

FIG. 12 is a diagram illustrating a history data number indicating a number of pieces of history data held by the job history manager 201 according to the first embodiment. FIG. 12 illustrates an example in which the history data number is four (corresponding to FIG. 13).

FIG. 13 is a diagram illustrating an example of the history data held by the job history manager 201 according to the first embodiment.

History ID 1301 indicates IDs for uniquely identifying the job history data. Job name 1302 indicates names of jobs registered as the history data, and for example, job names specified by the printer driver are set here. Date 1303 indicates a date on which the corresponding job was executed. Result 1304 indicates a result of executing the corresponding job, and “OK” is set in the case where printing was carried out according to the job attributes. “Not the same” is set in the case of a result output with different attributes than the original job attributes. In the first embodiment, “not the same” is indicated in the case where a job for which stapling is specified is output without stapling, the case where ID printing is forced by the operation mode. Image data 1305 indicates paths of image data of executed jobs stored in the auxiliary storage device 103. Job attribute data 1306 indicates paths of job attribute data of executed jobs stored in the auxiliary storage device 103. Initial print difference data 1307 indicates paths of data indicating differences from job attributes used in an initial print, stored in the auxiliary storage device 103.

In the example of the history data shown in FIG. 13, the results of executing “project proposal” and “specification” jobs indicated by reference numerals 1308 and 1309, respectively, are in accordance with the job attributes that correspond to those respective jobs. However, the results of executing “statement” and “design drawing” jobs indicated by reference numerals 1310 and 1311, respectively, differ from the job attributes that correspond to those respective jobs.

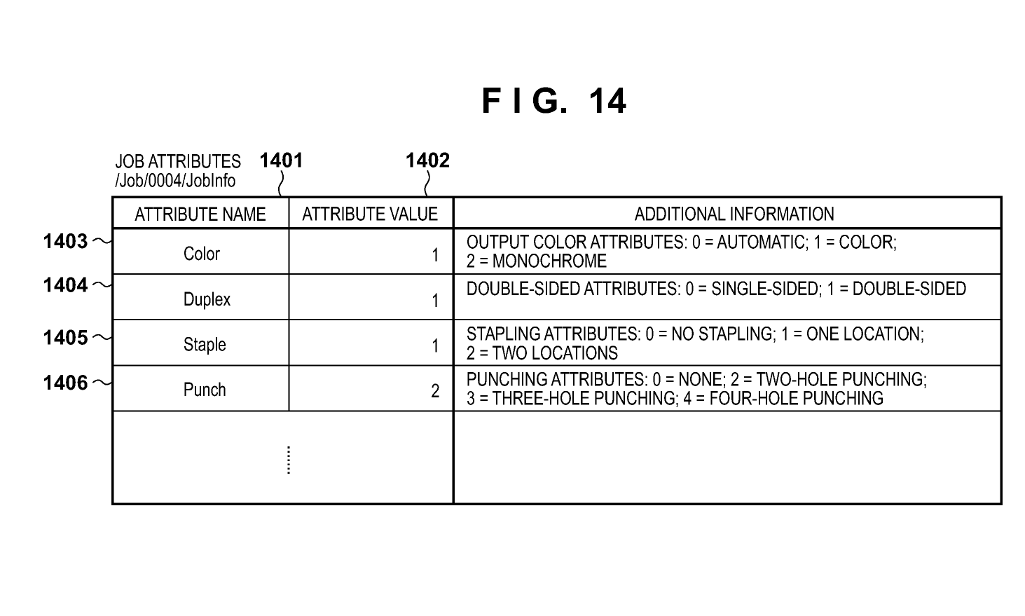

FIG. 14 is a diagram illustrating an example of the job attribute data in the job history data according to the first embodiment.

Attribute name 1401 indicates job attributes, and attribute value 1402 indicates attribute values of corresponding job attributes. The job attributes include color attributes 1403, double-sided attributes 1404, stapling attributes 1405, punching attributes 1406. In FIG. 14, color attributes 1403 is set to “1”, indicating that color printing is specified. Double-sided attributes 1404 is set to “1”, indicating that double-sided printing is specified. Stapling attributes 1405 is set to “1”, indicating that the document is to be stapled in one location. Punching attributes 1406 is set to “2”, indicating that two holes are to be punched in the document. The job attribute data may manage other job attributes aside from the aforementioned job attributes, or may include more detailed attribute values than the aforementioned attribute values; however, for the sake of simplicity, the first embodiment assumes that the attribute names and attribute values indicated in FIG. 14 are managed.

FIG. 4 depicts a view illustrating an example of a job history display screen displayed on the display unit 104 by the job history display 202 according to the first embodiment. This job history data corresponds to the history data shown in FIG. 13.

A job history display area 401 displays details of the job history data managed by the job history manager 201. Job name 402 indicates a display area for displaying the content of job name 1302 in FIG. 13. Date 403 indicates an area for displaying the content of date 1303 in FIG. 13. Initial result 404 is an area for displaying the content of result 1304 in FIG. 13. Initial result 404 displays “OK” in the case where the printing process is completed using the specified job attributes during the initial print and the job has not been processed using an operation mode. On the other hand, “not the same” is displayed in the case where the printing process has not been completed using the specified job attributes or in the case where the job has been processed using an operation mode. Reprint prediction 405 displays “OK” in the case where it is predicted that the job can be processed using the specified job attributes and the job will not be processed using an operation mode when reprinting the job, and displays “not the same” when such is not the case.

Scroll buttons 406 and 407 are buttons for scrolling the display content of the job history display area 401 when the job history display 202 cannot display all of the history data in the job history display area 401. A preview button 408 is a button for instructing the job history display 202 to display a preview of the job selected in the job history display area 401, and details thereof will be given in the second embodiment. A reprint button 409 is a button for instructing the job selected in the job history display area 401 to be reprinted, and details thereof will be given later with reference to FIG. 19.

In the example shown in FIG. 4, although the “project proposal” job was successfully printed and output according to the attributes of that job during the initial print, it is predicted that the “project proposal” job cannot be printed and output according to the attributes of that job when reprinting. Meanwhile, although the “statement” job could not be printed and output according to the attributes of that job during the initial print, it is predicted that the “statement” job can be printed and output according to the attributes of that job when reprinting. Finally, it is predicted that the “specification” and “design drawing” jobs will have the same respective printing results during the initial print and reprinting.

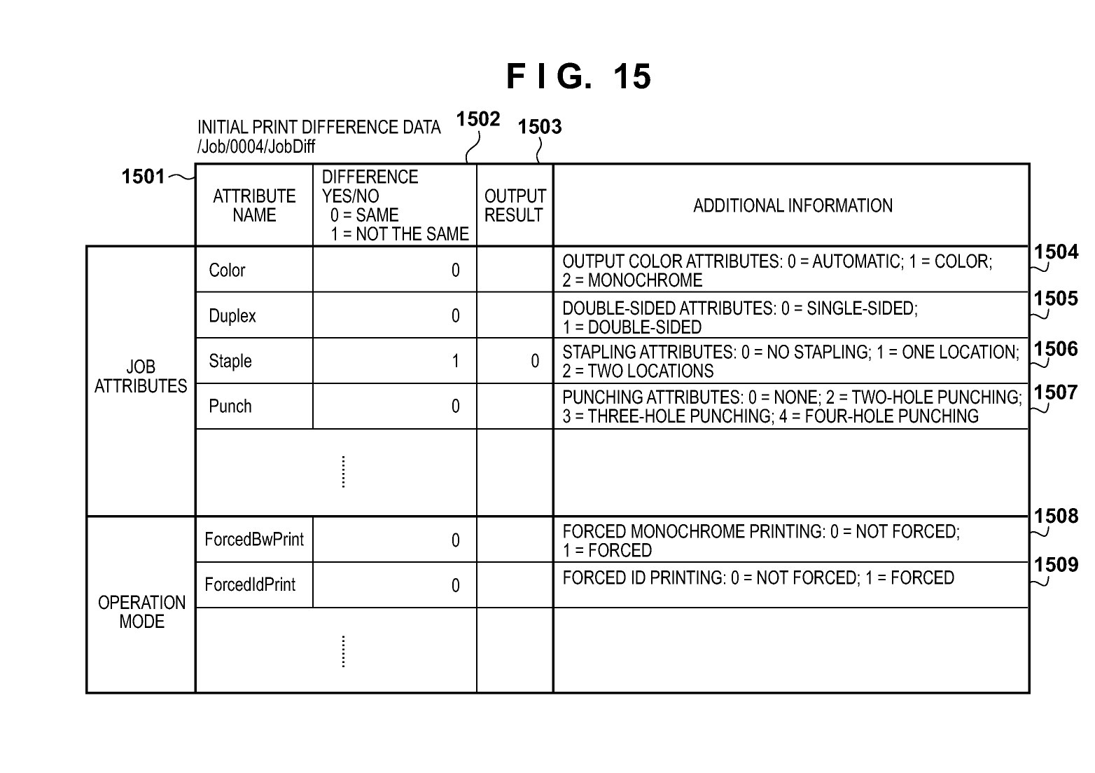

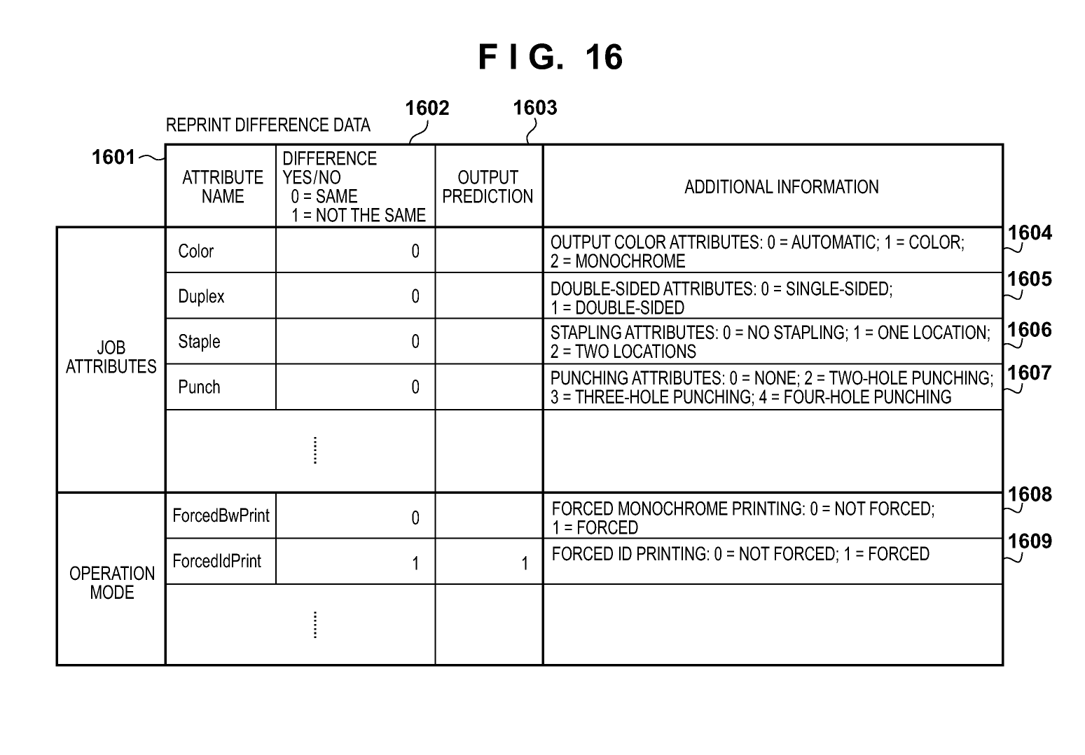

Next, the initial print difference data and the reprint difference data will be described with reference to FIGS. 15 and 16.

FIG. 15 is a diagram illustrating an example of the initial print difference data of the “design drawing” according to the first embodiment.

As described above, the initial print difference data indicates data resulting in a different output than that obtained according to the specified job attributes, information applied by an operation mode during the initial print. Attribute name 1501 indicates color attributes, double-sided attributes, stapling attributes, and punching attributes, as in the aforementioned FIG. 14. Difference yes/no 1502 indicates whether or not the output result matches the intended result of the job, and “0” indicates the result is the same, while “1” indicates the result is not the same. Output result 1503 indicates the output result. Note that “0” is set as a default value in difference yes/no 1502.

Reference numeral 1504 denotes color attribute difference data, reference numeral 1505 denotes double-sided attribute difference data, reference numeral 1506 denotes stapling attribute difference data, and reference numeral 1507 denotes punching attribute difference data. Reference numeral 1508 denotes whether or not forced monochrome printing is applied, whereas reference numeral 1509 denotes whether or not forced ID printing is applied.

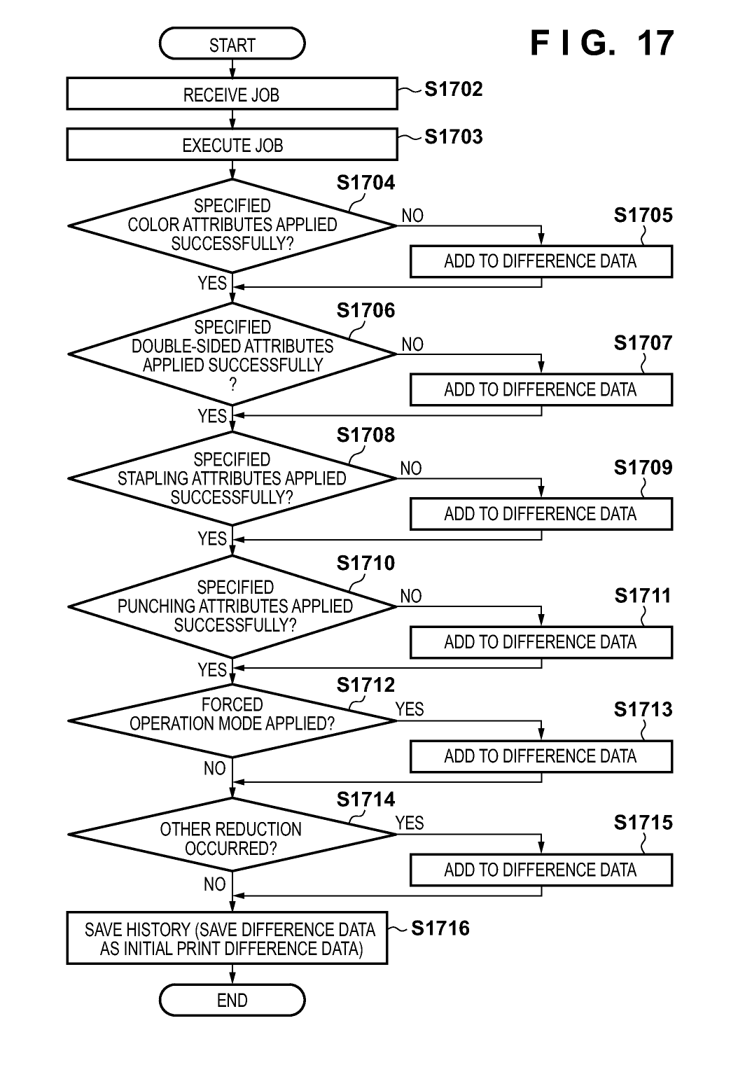

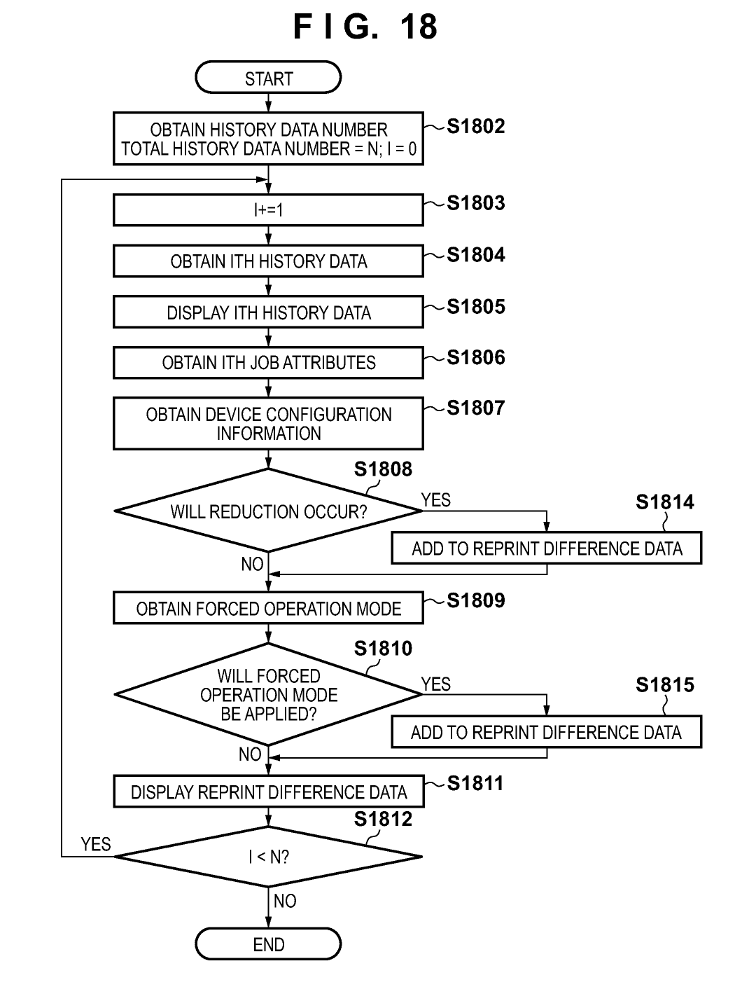

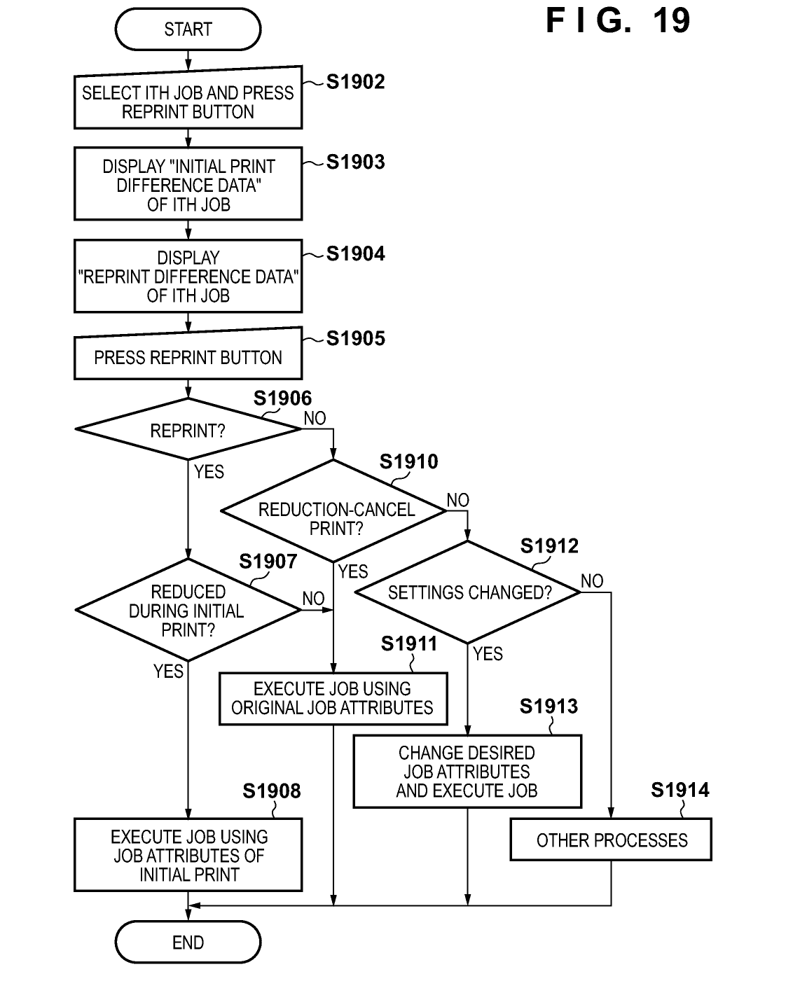

This example of the initial print difference data indicates that the job could not be processed with job settings specifying a stapling attribute, that is, “staple” of the attribute name 1501; to be more specific, the job was output without stapling, indicated by “0”. In other words, referring to the job attributes shown in FIG. 14, a single location is specified to be stapled by the job settings in FIG. 14, but the output result 1503 in FIG. 15 is “0”, thus indicating that the job was output without stapling. Details of methods for managing and using the initial print difference data will be described later with reference to the flowcharts in FIGS. 17 and 18.

FIG. 16 is a diagram illustrating an example of reprint difference data according to the first embodiment.

As described earlier, the reprint difference data indicates data added in the case where job attributes specified in an initial print cannot be processed in a reprint. Attribute name 1601 and difference yes/no 1602 correspond to the aforementioned items in FIG. 15. Reference numeral 1603 denotes an output prediction. Reference numeral 1604 denotes color attribute difference data, reference numeral 1605 denotes double-sided attribute difference data, reference numeral 1606 denotes stapling attribute difference data, and reference numeral 1607 denotes punching attribute difference data. Reference numeral 1608 denotes whether or not forced monochrome printing is applied, and reference numeral 1609 denotes whether or not forced ID printing is applied. The example of the reprint difference data shown in FIG. 16 indicates that stapling can be executed in accordance with the stapling attributes and forced ID printing 1609 will be executed. Details of a method for using the reprint difference data will be described later with reference to the flowchart in FIG. 19.

FIG. 17 is a flowchart for describing a printing process performed by the image forming apparatus according to the first embodiment during an initial print. Note that a program that executes this process is installed in the auxiliary storage device 103 and is loaded into the RAM 102 at execution, and the process indicated in the flowchart is executed by the CPU 101 implementing the stated program. Note also that this process corresponds to a process executed by the job controller 203 indicated in FIG. 2.

First, in step S1702, the CPU 101 receives a print job that employs the copy function, the printer function, or the like; the print job includes image data, job attributes. The process then advances to step S1703, where the CPU 101 executes the print job. At this time, the CPU 101 executes the print job using the printing unit 107, and the CPU 101 can confirm the various types of data used in the execution. The process then advances to step S1704, where the CPU 101 determines whether or not color attributes specified in the job attributes have been successfully applied; in the case where it has been determined that the color attributes have been successfully applied, the process advances to step S1706. On the other hand, in the case where it has been determined that the color attributes have not been successfully applied, the process advances to step S1705, where data indicating that the color attributes were not successfully applied is added to the initial print difference data (1502 in FIG. 15), after which the process advances to step S1706.

In step S1706, the CPU 101 determines whether or not double-sided attributes specified in the job attributes have been successfully applied; in the case where it has been determined that the double-sided attributes have been successfully applied, the process advances to step S1708. On the other hand, in the case where it has been determined that the double-sided attributes have not been successfully applied, the process advances to step S1707, where data indicating a difference in the double-sided attributes is added to the initial print difference data (1502 in FIG. 15), after which the process advances to step S1708.

In step S1708, the CPU 101 determines whether or not stapling attributes specified in the job attributes have been successfully applied; in the case where it has been determined that the stapling attributes have been successfully applied, the process advances to step S1710. On the other hand, in the case where it has been determined that the stapling attributes have not been successfully applied, the process advances to step S1709, where data indicating a difference in the stapling attributes is added to the initial print difference data (1502 in FIG. 15), after which the process advances to step S1710.

In step S1710, the CPU 101 determines whether or not punching attributes specified in the job attributes have been successfully applied; in the case where it has been determined that the punching attributes have been successfully applied, the process advances to step S1712. On the other hand, in the case where it has been determined that the punching attributes have not been successfully applied, the process advances to step S1711, where data indicating a difference in the punching attributes is added to the initial print difference data (1502 in FIG. 15), after which the process advances to step S1712.

In step S1712, the CPU 101 determines whether or not a forced operation mode indicated in FIG. 3 has been applied, and in the case where it is determined that the forced operation mode has not been applied, the process advances to step S1714. On the other hand, in the case where it has been determined that the forced operation mode has been applied, the process advances to step S1713, where data indicating a difference in the forced operation mode is added to the initial print difference data (1502 in FIG. 15), after which the process advances to step S1714.

In step S1714, the CPU 101 determines whether or not a reduction has occurred with respect to other job attributes, and in the case where it is determined that a reduction has not occurred, the process advances to step S1716. On the other hand, in the case where it has been determined that a reduction has occurred, the process advances to step S1715, where data indicating that a reduction has occurred is added to the initial print difference data (1502 in FIG. 15), after which the process advances to step S1716. Here, the “other job attributes” can be any given job attributes, such as folding settings, binding settings, or the like; however, details thereof will be omitted from the first embodiment. Then, in step S1716, the CPU 101 stores the image data, job attributes, the initial print difference data of the print job received in step S1702 in the auxiliary storage device 103 as the job history data. At this time, the CPU 101 also updates the history data number in FIG. 12 and the history data in FIG. 13.

FIG. 18 is a flowchart for describing a process for displaying the job history display screen (FIG. 4) performed by the image forming apparatus according to the first embodiment. Note that a program that executes this process is installed in the auxiliary storage device 103 and is loaded into the RAM 102 at execution, and the process indicated in the flowchart is executed by the CPU 101 executing the stated program. Note also that this process corresponds to a process executed by the job history display 202 indicated in FIG. 2.

First, in step S1802, the CPU 101 refers to the history data number (FIG. 12), sets that history data number in a variable N that indicates the history data number, and resets an increment variable I to “0”. Note that the variables N and I are provided in the RAM 102. The process then advances to step S1803, where the CPU 101 increments the variable I (that is, adds 1 thereto). The process then advances to step S1804, where the CPU 101 obtains Ith history data indicated by the variable I from the history data indicated in FIG. 13; then, in step S1805, that history data is displayed in the job history display area 401 shown in FIG. 4. At this time, the job name 402, the date 403, and the initial result 404 are displayed by the same content as the job name 1302, the date 1303, and the result 1304 shown in FIG. 13.

The process advances to step S1806, where the CPU 101 refers to the job attribute data 1306 in FIG. 13 and obtains the job attribute data of the Ith job. The process then advances to step S1807, where the CPU 101 executes a configuration information obtainment process for obtaining device configuration information of the printing unit 107. The process then advances to step S1808, where the CPU 101 compares the job attribute data obtained in step S1806 with the device configuration information obtained in step S1807 and determines whether or not a reduction will occur when the job is re-executed. In the case where it is determined that a reduction will not occur, the process advances to step S1809; however, in the case where it is determined that a reduction will occur, the process advances to step S1814, where the CPU 101 adds the corresponding difference data to the reprint difference data shown in FIG. 16, after which the process advances to step S1809. The example in FIG. 16 indicates a case where a reduction will not occur when the job is re-executed.

Next, in step S1809, the CPU 101 obtains the forced operation mode information shown in FIG. 3, after which the process advances to step S1810. In step S1810, it is determined whether or not a forced operation will be applied. In the case where it is determined here that the forced operation will not be applied, the process advances to step S1811. On the other hand, in the case where it is determined that the forced operation will be applied, the process advances to step S1815, where data indicating that the forced operation will be applied is added to the reprint difference data shown in FIG. 16; the process then advances to step S1811. The example shown in FIG. 16 indicates that when the job is re-executed, forced ID printing will be applied during the re-execution.

In this manner, the CPU 101 displays “not the same” in the reprint prediction 405 of the job history display area 401 (FIG. 4) in step S1811 in the case where it has been determined in step S1808 that the job will be printed with different job attributes or in the case where it has been determined in step S1810 that the forced operation mode will be applied. On the other hand, the CPU 101 displays “OK” in the reprint prediction 405 of the job history display area 401 in step S1811 in the case where it has been determined in step S1808 that printing will be executed according to the job attributes and in the case where it has been determined in step S1810 that the forced operation mode will not be applied. When reprint difference data that corresponds to the job prediction is displayed in step S1811 in this manner, the process advances to step S1812, where it is determined whether the value of the variable I matches the variable N indicating the history data number. The process returns to step S1803 in the case where it is determined that the variables do not match, after which the variable I is incremented (that is, 1 is added thereto) and the same processes as described above are executed. However, in the case where it is determined in step S1812 that all of the history data managed in the history data shown in FIG. 13 has been displayed in the job history display area 401 (that is, I=N), the display process ends.

After this, the CPU 101 (the job history display 202 and the job controller 203) can refer to the printed job history data (FIG. 13), the job attributes (FIG. 14), the initial print difference data (FIG. 15), and the reprint difference data (FIG. 16) at any given time.

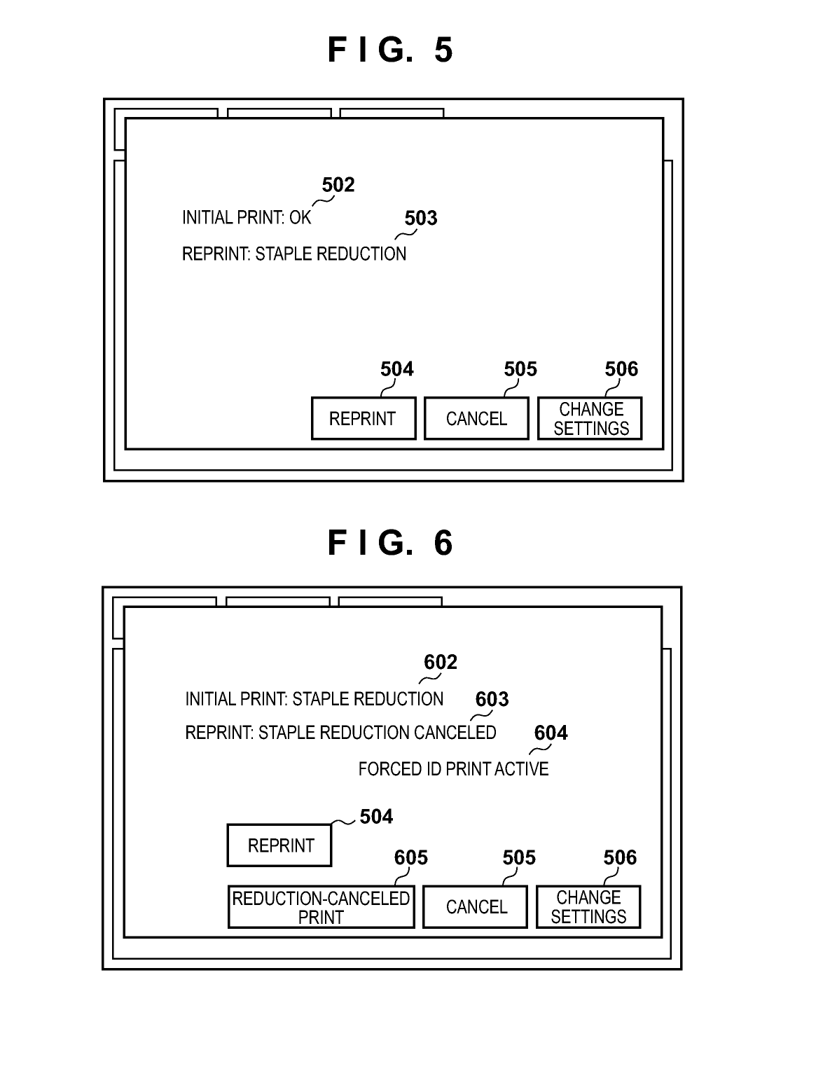

FIG. 5 depicts a view illustrating an example of a reprinting screen displayed by the image forming apparatus according to the first embodiment when a job is selected in the job history display screen shown in FIG. 4 by specifying the job name 402 and the reprint button 409 is pressed.

Reference numeral 502 denotes an initial print result; here, “OK” is displayed, indicating that printing was executed according to job attribute data based on, for example, the attribute information shown in FIG. 13, and that forced operation mode control was not performed when the printing was executed. Reference numeral 503 denotes that the stapling attributes cannot be applied, or in other words, the stapling attributes will be reduced when that job is instructed to be reprinted. Based on the details indicated by reference numerals 502 and 503, the user can identify that the output result will differ between the initial print and the reprint.

When the user presses a cancel button 505 in the reprinting screen, the CPU 101 closes the reprinting screen. Meanwhile, when the user presses a change settings button 506, the printing attributes of that job can be changed; however, this process is of no relation to the present invention, and thus descriptions thereof will be omitted. Processes performed when the user presses a reprint button 504 will be described later.

FIG. 6 depicts a view illustrating another example of a reprinting screen displayed by the image forming apparatus according to the first embodiment when a job is selected in the job history display screen shown in FIG. 4 by specifying the job name 402 and the reprint button 409 is pressed.

“Staple reduction”, denoted by reference numeral 602, indicates that the stapling attributes 1405 specified in the job attributes shown in FIG. 14 have been reduced in the initial print. “Staple reduction canceled”, denoted by reference numeral 603, indicates that the reduction of the stapling function that was reduced in the initial print can be canceled, and the printing can be executed, during the reprint; in other words, the stapling function can be executed in the reprint. Furthermore, “forced ID print active”, indicated by reference numeral 604, displays the content of the forced ID print 1609 in the reprint difference data shown in FIG. 16. Based on the details indicated by reference numerals 602, 603, and 604, the user can identify that the output result will differ between the initial print and the reprint.

In the case where job attributes that could not be used in the initial print can be used in the reprint, the first embodiment provides a reprint mode for obtaining the same results as the initial print and a reduction-canceled print mode for canceling the reduction and executing the print with a different result from the initial print. In other words, in the case where job attributes were reduced in the initial print but the reduction can be canceled and the job attributes can be processed in the reprint, the reprint mode is provided for obtaining the same reduced result as the initial print, or the reduction-canceled print mode is provided for canceling the reduction and executing the print.

The reprint button 504 is a button for specifying the reprint mode for obtaining the same result as the initial print. A reduction-canceled print button 605 is a button for specifying a print mode that uses a function reduced in the initial print (stapling, in this example) but that can be used in a reprint (that is, a print mode that cancels the reduction). Details of processes performed when the user presses the reprint button 504 or the reduction-canceled print button 605 will be given later. Meanwhile, the screen shown in FIG. 6 is closed when the user presses the cancel button 505. Note that processes performed when the user presses the change settings button 506 are of no relation to the present invention, and thus descriptions thereof will be omitted.

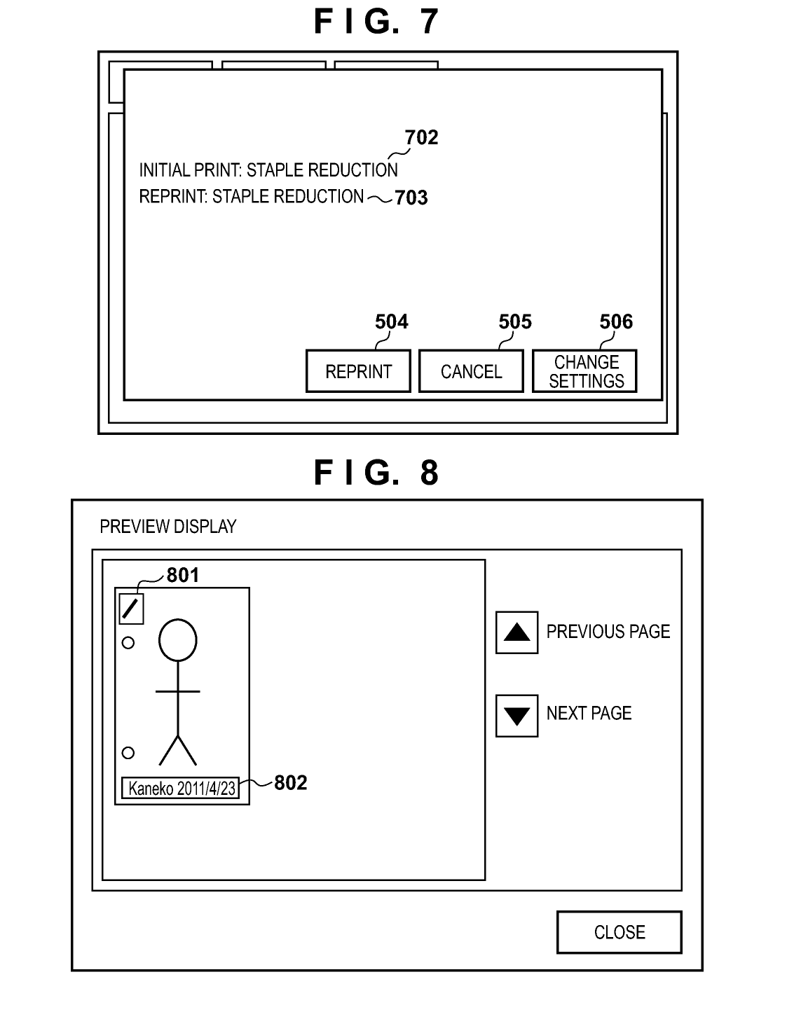

FIG. 7 depicts a view illustrating yet another example of a reprinting screen displayed by the image forming apparatus according to the first embodiment when a job is selected in the job history display screen shown in FIG. 4 by specifying the job name 402 and the reprint button 409 is pressed.

“Staple reduction”, denoted by reference numeral 702, indicates that the stapling attributes 1405 specified in the job attributes shown in FIG. 14 have been reduced in the initial print. “Staple reduction”, denoted by reference numeral 703, indicates that the stapling function reduced in the initial print will remain reduced in a reprint; in other words, the stapling function cannot be used in the reprint, in the same manner as in the initial print.

In the reprint screen shown in FIG. 7, the details indicated by reference numerals 702 and 703 make it possible to confirm that the output result will be the same in both the initial print and in the reprint.

FIG. 19 is a flowchart for describing a process performed by the image forming apparatus according to the first embodiment when the user selects a job in the job history display screen shown in FIG. 4 and presses the reprint button 409. Note that a program that executes this process is installed in the auxiliary storage device 103 and is loaded into the RAM 102 at execution, and the process indicated in the flowchart is executed by the CPU 101 executing the stated program. Note also that this process corresponds to processes executed by the job history display 202 and the job controller 203 indicated in FIG. 2.

First, in step S1902, the CPU 101 detects that the user has selected the Ith job in the job history display area 401 shown in FIG. 4 and pressed the reprint button 409. The process advances to step S1903 as a result, where the CPU 101 displays the details of the initial print difference data (FIG. 15) obtained through the process indicated by the flowchart in FIG. 18 in, for example, the reprinting screens shown in FIGS. 5 to 7. The process then advances to step S1904, where the CPU 101 displays the details of the reprint difference data (FIG. 16) obtained through the process indicated by the flowchart in FIG. 18 in, for example, the reprinting screens shown in FIGS. 5 to 7. In step S1905, the CPU 101 waits for a user to press any button on the screen as shown in FIGS. 5 to 7, and if the user presses a button, then the process advances to step S1906.

In step S1906, where the CPU 101 determines whether or not the reprint button 504 was pressed in, for example, the aforementioned screens shown in FIGS. 5 to 7. In the case where the user has pressed the reprint button 504, the process advances to step S1907, where the CPU 101 determines whether or not there was a reduction in the initial print. In the case where there was no reduction in the initial print, the process advances to step S1911, where the CPU 101 executes the reprint job according to the content of the original attributes of that job (FIG. 14), after which the process ends.

However, in the case where the CPU 101 has determined in step S1907 that there was a reduction in the initial print, the process advances to step S1908, where the CPU 101 executes the reprint job according to the content of the job attributes used during the initial print (FIG. 14). Step S1908 makes it possible for the same processing result to be obtained in the reprint as in the initial print, even in the case where, for example, stapling attributes were reduced in the initial print but the stapling reduction is canceled in the reprint.

On the other hand, in the case where the user has pressed the reduction-canceled print button 605 in step S1905, the process advances from step S1906 to step S1910 and on to step S1911, where the CPU 101 executes the reprint job according to the content of the original attributes of that job. This corresponds to, for example, a case where stapling was reduced in the initial print because the staples had run out but the stapling can be executed in the reprint job according to the stapling attributes because the staples have been refilled.

Meanwhile, in the case where the user has pressed the change settings button 506 in step S1905, the process advances from step S1910 to step S1912 and on to step S1913, where the user can change desired job attributes and execute a reprint; however, descriptions thereof are inconsequential to the present invention and will thus be omitted.

In the case where the user has selected another function in step S1905, the process advances to step S1914, where the CPU 101 executes the other process; the process indicated by the flowchart in FIG. 19 then ends. This “other process” is, for example, a process for closing the screens indicated in FIGS. 5, 6, and 7 by pressing the cancel button 505 or the like.

According to the first embodiment as described thus far, it is easy to identify a printing result in an initial print and a predicted printing result in a reprint using a job history display screen, which improves the convenience.

In addition, when reprinting a job that had a reduction in the initial print, it is possible to select between printing without reducing the attributes of that job or printing with the reduction as-is. This makes it possible for the user to obtain a desired output result from the reprint.

### Second Embodiment

A second embodiment describes a preview display that, in an image forming apparatus capable of reprinting an already-printed job, enables a difference between an initial print and a reprint to be confirmed in a preview screen. Note that the configuration of the image forming apparatus, the configuration of programs, and so on according to the second embodiment are the same as those described in the above first embodiment, and thus descriptions thereof will be omitted.

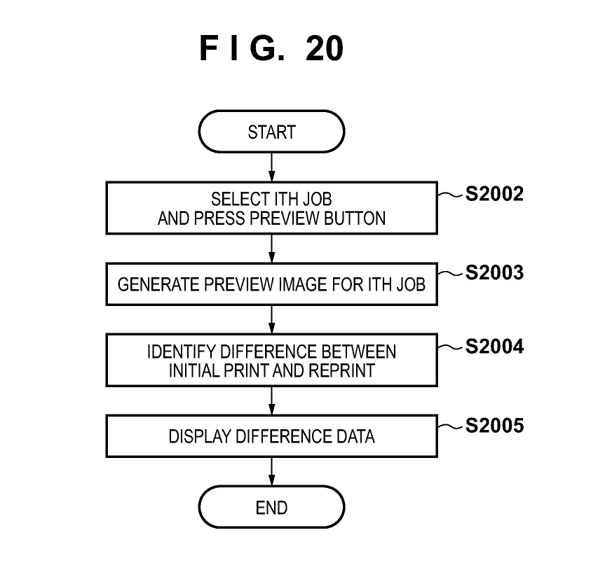

FIG. 20 is a flowchart for describing a process performed by the image forming apparatus according to the second embodiment when displaying a preview of a job. Note that a program that executes this process is installed in the auxiliary storage device 103 and is loaded into the RAM 102 at execution, and the process indicated in the flowchart is executed by the CPU 101 executing the stated program.

First, in step S2002, the CPU 101 detects that the user has selected a job by specifying the job name 402 in the job history display area 401 in FIG. 4 and pressed the preview button 408. As a result, the process advances to step S2003, where the CPU 101 obtains the image data of the selected job based on the path in the image data 1305 in FIG. 13 and generates a preview image of that job.

In the second embodiment, elements indicated in FIG. 10 are superimposed on the preview image generated based on the image data obtained from the path indicated by the image data 1305. As a result, the job attributes specified as indicated in FIG. 14 can also be expressed in the preview screen.

FIG. 10 is a diagram illustrating display elements that indicate stapling and punching attributes, displayed in the preview image according to the second embodiment.

Reference numeral 1001 denotes a display element used in the case of an output in which stapling is specified in only one location. Reference numeral 1002 denotes a display element used in the case of an output in which stapling is specified in two locations. Reference numeral 1003 denotes a display element used in the case of an output in which two-hole punching is specified. Reference numeral 1004 denotes a display element used in the case of an output in which three-hole punching is specified. Reference numeral 1005 denotes a display element used in the case of an output in which four-hole punching is specified.

In actuality, it is preferable to provide display elements that take into consideration the positions (top and bottom, left and right) of the staples and punch holes, intervals between the punch holes, but the second embodiment omits descriptions of such detailed display elements for the sake of simplicity.

After step S2003, the process advances to step S2004, where when executing the preview display, the CPU 101 obtains the job attributes (FIG. 14), the initial print difference data (FIG. 15), and the reprint difference data (FIG. 16) confirmed through the process illustrated in FIG. 18 and described in the first embodiment. Then, in step S2005, the CPU 101 reflects the difference data and so on in the preview display.

FIG. 8 depicts a view illustrating an example of a preview screen displayed by the image forming apparatus according to the second embodiment when a job is selected in the screen shown in FIG. 4 and the preview button 408 is pressed.

In FIG. 8, reference numeral 801 denotes stapling in a single location, and reference numeral 802 denotes that forced ID printing is applied. The details indicated by reference numerals 801 and 802 show locations where the result will differ between the initial print and the reprint, and FIG. 8 illustrates an example of the preview display in which those locations are surrounded by frames so that the locations can be identified.

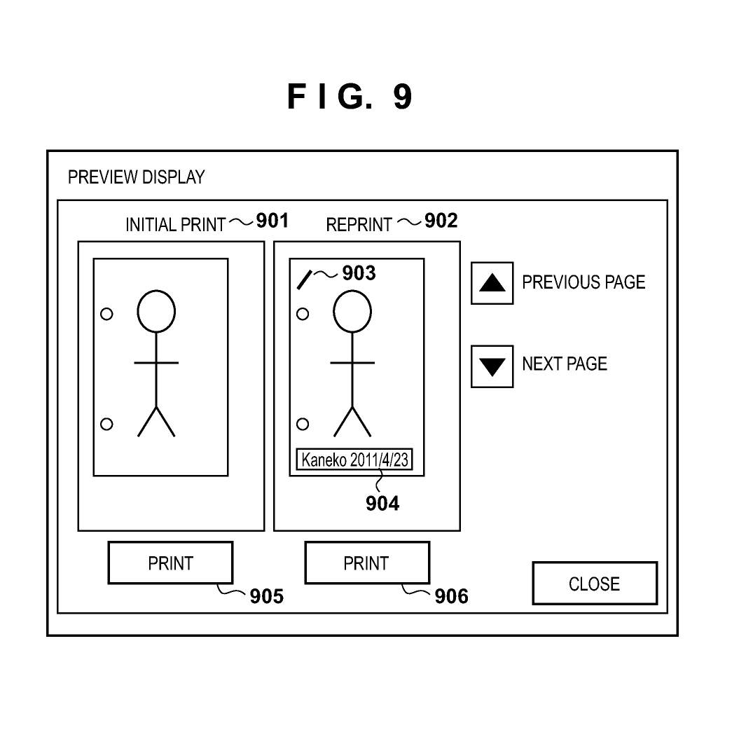

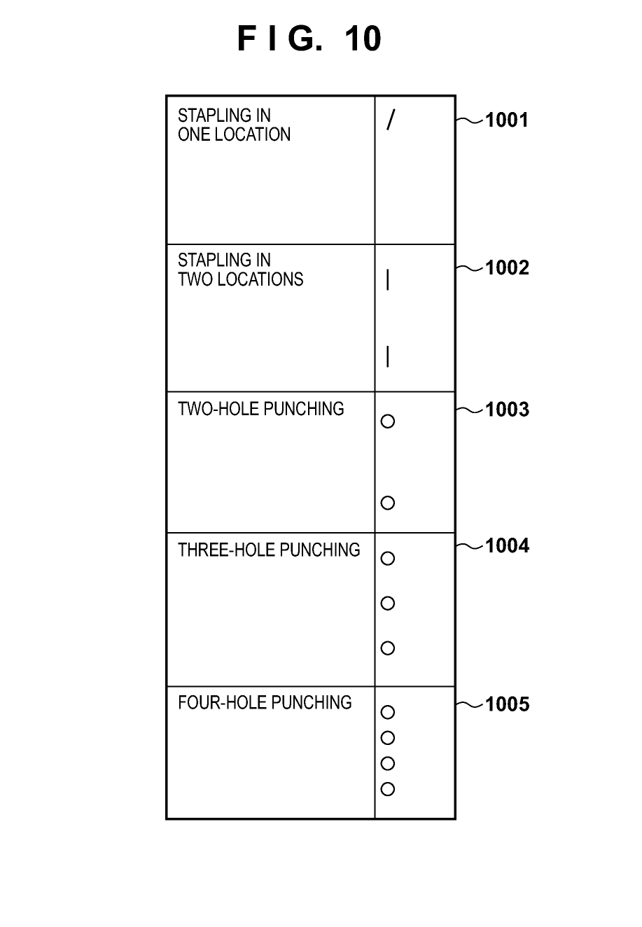

FIG. 9 depicts a view illustrating an example of a screen displayed by the image forming apparatus according to the second embodiment that arranges an initial print preview display and a reprint preview display so that the respective previews can be compared.

In FIG. 9, reference numeral 901 denotes an initial print result preview, whereas reference numeral 902 denotes a predicted reprint result preview. From FIG. 9, it can be seen that the differences between the initial print and the reprint are staple settings (stapling in one location) indicated by reference numeral 903 and forced ID printing indicated by reference numeral 904.

In addition, in FIG. 9, a print button 905 is provided at the bottom of a region for the initial print preview display, and a print button 906 is provided at the bottom of a region for the reprint preview display. In the case where the user has pressed the print button 905, reprinting can be carried out by executing the processes of steps S1906 to S1908 and S1911 in FIG. 19. In other words, the print button 905 is a button for instructing reprinting to be carried out using the same job attributes as in the initial print.

On the other hand, in the case where the user has pressed the print button 906, the reprinting can be carried out through the processes of steps S1910 and S1911 in FIG. 19, having applied job attributes that were reduced in the initial print (that is, canceling the reduction). In other words, the print button 906 is a button for instructing reprinting to be carried out using the same job attributes as in the reprint preview display when executing a reprint.

According to the second embodiment as described above, differences in output results between an initial print and a reprint can be confirmed in a preview screen prior to executing the print, which has an effect that the differences can be identified with ease.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such changes and equivalent structures and functions.

This application claims the benefit of Japanese Patent Application No. 2012-245632, filed Nov. 7, 2012, which is hereby incorporated by reference herein in its entirety.

What is claimed is:

1. An image forming apparatus comprising:
a reception unit configured to receive a print job containing a first job attribute;
an obtaining unit configured to obtain information indicating a function or a status of the image forming apparatus;
a determination unit configured to determine whether or not to be able to execute the print job in accordance with the first job attribute, based upon the information obtained by the obtaining unit;
an execution unit configured to execute the print job in accordance with the first job attribute in a case that it is determined by the determination unit that the print job is able to be executed in accordance with the first job attribute, or to execute the print job in accordance with a second job attribute, in a case that it is determined by the determination unit that the print job is not able to be executed in accordance with the first job attribute;
a storage unit configured to store the print job that is determined not to be executed in accordance with the first job attribute and has been executed by the execution unit together with the second job attribute; and
a control unit configured to, in a case that re-execution of a print job stored in the storage unit is designated, control the execution unit to re-execute the designated print job in accordance with the second job attribute.

2. The image forming apparatus according to claim 1, wherein the storage unit further stores the first job attribute of the print job, and further comprising:
a designation unit configured to, in a case that re-execution of a print job stored in the storage unit is designated, designate whether the print job is re-executed in accordance with the first job attribute or the second job attribute.

3. The image forming apparatus according to claim 2,
wherein the determination unit further determines, in a case that re-execution of a print job stored in the storage unit is designated, whether or not the print job is able to be executed in accordance with the first job attribute.

4. The image forming apparatus according to claim 2, further comprising:
a display unit configured to display respective images that indicate an execution result of the print job that is to be executed in accordance with the first job attribute and an execution result of the print job that is to be executed in accordance with the second job attribute.

5. The image forming apparatus according to claim 1,
wherein the first and second job attributes include at least one of color or monochrome printing, double-sided printing, stapling, and punching.

6. The image forming apparatus according to claim 1,
wherein the storage unit stores an execution result of the print job executed by the execution unit together with the second job attribute.

7. The image forming apparatus according to claim 4, wherein the display unit further displays difference information indicating a difference between the first job attribute and the second job attribute in association with the print job.

8. A method for controlling an image forming apparatus, the method comprising:
a reception step of receiving a print job containing a first job attribute;
an obtaining step of obtaining information indicating a function or a status of the image forming apparatus;
a determination step of determining whether or not to be able to execute the print job in accordance with the first job attribute, based upon the information obtained in the obtaining step;
an execution step of executing the print job in accordance with the first job attribute in a case that it is determined in the determination step that the print job is able to be executed in accordance with the first job attribute, or to execute the print job in accordance with a second job attribute, in a case that it is determined in the determination step that the print job is not able to be executed in accordance with the first job attribute;
a storage step of storing the print job that is determined not to be executed in accordance with the first job attribute and has been executed in the execution step together with the second job attribute; and
a control step of, in a case that re-execution of a print job stored in the storage step is designated, controlling the execution step to re-execute the designated print job in accordance with the second job attribute.

9. A non-transitory computer-readable storage medium on which is stored a program for causing a computer to function as the image forming apparatus according to claim 1.
